(19) United States
(12) Patent Application Publication
(10) Pub. No.: US 2022/0230330 A1
(43) Pub. Date: Jul. 21, 2022

(54) ESTIMATION DEVICE, ESTIMATION METHOD, AND NON-TRANSITORY COMPUTER-READABLE MEDIUM

(71) Applicant: NEC Corporation, Minato-ku, Tokyo (JP)

(72) Inventor: Kenta ISHIHARA, Tokyo (JP)

(73) Assignee: NEC Corporation, Minato-ku, Tokyo (JP)

(21) Appl. No.: 17/614,044

(22) PCT Filed: May 31, 2019
(86) PCT No.: PCT/JP2019/021662

§ 371 Date: Nov. 24, 2021

(51) Int. Cl. G06T 7/246; G06V 10/77

(52) U.S. Cl. CPC G06T 7/246; G06T 2207/20084; G06V 10/7715

(57) ABSTRACT

In an estimation device, an acquisition unit acquires a “plurality of images”. The “plurality of images” are images in each of which a “real space” is captured, and have mutually different capture times. The acquisition unit acquires information related to a “capture period length”, which corresponds to a difference between an earliest time and a latest time of the plurality of times that correspond the “plurality of images”, respectively. An estimation unit estimates a position of an “object under estimation” on an “image plane” and a movement velocity of the “object under estimation” in the real space, based on the “plurality of images” and the information related to the “capture period length” acquired. The “image plane” is an image plane of each acquired image.

### TECHNICAL FIELD

The present disclosure relates to an estimation device, an estimation method, and a non-transitory computer-readable medium.

### BACKGROUND ART

Movement velocity of an object captured in a video is useful information in abnormality detection and behavior recognition. Various techniques are proposed that use a plurality of images captured at mutually different capture times to estimate a movement velocity of an object captured in the images (for example, Non Patent Literature 1, Patent Literature 1).

For example, Non Patent Literature 1 discloses a technique that estimates, from a video captured by an in-vehicle camera, a relative velocity of another vehicle with respect to a vehicle equipped with the in-vehicle camera. According to the technique, based on two images with different times in the video, a depth image, tracking information, and motion information about motion in the images are estimated for each vehicle size in the images, and a relative velocity of a vehicle and a position of the vehicle are estimated by using the estimated depth image, tracking information, and motion information.

### CITATION LIST

### Patent Literature

Patent Literature 1: Japanese Unexamined Patent Application Publication No. H09-293141

### Non Patent Literature

Non Patent Literature 1: M. Kampelmuhler et al., “Camera-based Vehicle Velocity Estimation from Monocular Video”, Proceedings of 23rd Computer Vision Winter Workshop.

### SUMMARY OF INVENTION

### Technical Problem

The present inventor has found the possibility that accuracy in estimation of a movement velocity of an object captured in images may decrease, in the techniques disclosed in Non Patent Literature 1, Patent Literature 1. For example, in some cases, time intervals between a plurality of acquired images vary depending on performance of a camera used for capture, or calculation throughput, a communication state, or the like of a monitoring system including the camera. In the technique disclosed in Non Patent Literature 1, there is a possibility that while a movement velocity can be estimated with a decent level of accuracy with respect to a plurality of images with a certain time interval in between, accuracy in estimation of a movement velocity may decrease with respect to images with another time interval in between. The same is true for Patent Literature 1, because Patent Literature 1 is also premised on use of a plurality of images at predetermined time intervals. In other words, in estimation of a movement velocity of an object captured in images, the techniques disclosed in Non Patent Literature 1, Patent Literature 1 do not take cases into consideration at all in which “capture period lengths” of and “capture interval lengths” between a plurality of images used for the estimation may vary, and there is therefore a possibility that estimation accuracy may decrease.

An object of the present disclosure is to provide an estimation device, an estimation method, and a non-transitory computer-readable medium that can improve accuracy in estimation of a movement velocity of an object captured in images.

### Solution to Problem

An estimation device according to a first aspect includes: an acquisition unit configured to acquire a plurality of images and information related to a capture period length or a capture interval length, the plurality of images being images in each of which a real space is captured and having mutually different capture times, the capture period length corresponding to a difference between an earliest time and a latest time of the plurality of times that correspond to the plurality of images, respectively, the capture interval length corresponding to a difference between the times of two images that are next to each other when the plurality of images are arranged in chronological order of the capture times; and an estimation unit configured to estimate a position of an object under estimation on an image plane and a movement velocity of the object under estimation in the real space, based on the plurality of images and the information related to the capture period length or the capture interval length acquired.

An estimation method according to a second aspect includes: acquiring a plurality of images and information related to a capture period length or a capture interval length, the plurality of images being images in each of which a real space is captured and having mutually different capture times, the capture period length corresponding to a difference between an earliest time and a latest time of the plurality of times that correspond to the plurality of images, respectively, the capture interval length corresponding to a difference between the times of two images that are next to each other when the plurality of images are arranged in chronological order of the capture times; and estimating a position of an object under estimation on an image plane and a movement velocity of the object under estimation in the real space, based on the plurality of images and the information related to the capture period length or the capture interval length acquired.

A non-transitory computer-readable medium according to a third aspect stores a program, the program causing an estimation device to execute processing including: acquiring a plurality of images and information related to a capture period length or a capture interval length, the plurality of images being images in each of which a real space is captured and having mutually different capture times, the capture period length corresponding to a difference between an earliest time and a latest time of the plurality of times that correspond to the plurality of images, respectively, the capture interval length corresponding to a difference between the times of two images that are next to each other when the plurality of images are arranged in chronological order of the capture times; and estimating a position of an object under estimation on an image plane and a movement velocity of the object under estimation in the real space, based on the plurality of images and the information related to the capture period length or the capture interval length acquired.

### Advantageous Effects of Invention

According to the present disclosure, it is possible to provide an estimation device, an estimation method, and a non-transitory computer-readable medium that can improve accuracy in estimation of a movement velocity of an object captured in images.

### BRIEF DESCRIPTION OF DRAWINGS

FIG. 1 is a block diagram showing an example of an estimation device in a first example embodiment.

FIG. 2 is a block diagram showing an example of an estimation system including an estimation device in a second example embodiment.

FIG. 3 shows an example of input data for an estimation unit.

FIG. 4 shows an example of a relation between a camera coordinate system and a real-space coordinate system.

FIG. 5 shows an example of a likelihood map and a velocity map.

FIG. 6 is a flowchart showing an example of processing operation of the estimation device in the second example embodiment.

FIG. 7 is a block diagram showing an example of an estimation system including an estimation device in a third example embodiment.

FIG. 8 is a flowchart showing an example of processing operation of the estimation device in the third example embodiment.

FIG. 9 shows an example of a hardware configuration of an estimation device.

### DESCRIPTION OF EMBODIMENTS

Hereinafter, example embodiments will be described with reference to drawings. Note that throughout the example embodiments, the same or similar elements are denoted by the same reference signs, and an overlapping description is omitted.

### First Example Embodiment

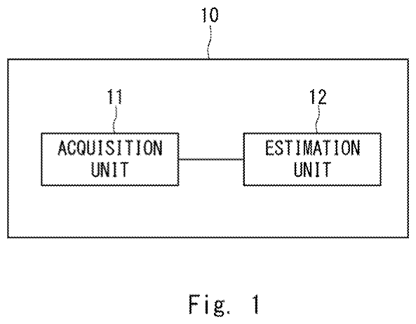

FIG. 1 is a block diagram showing an example of an estimation device in a first example embodiment. In FIG. 1, an estimation device 10 includes an acquisition unit 11 and an estimation unit 12.

The acquisition unit 11 acquires a “plurality of images”. The “plurality of images” are images in each of which a “real space” is captured, and have mutually different capture times. The acquisition unit 11 acquires information related to a “capture period length”, which corresponds to a difference between an earliest time and a latest time of the plurality of times that correspond to the “plurality of images”, respectively, or related to a “capture interval length”, which corresponds to a difference between the times of two images that are next to each other when the “plurality of images” are arranged in chronological order of the capture times.

The estimation unit 12 estimates a position of an “object under estimation” on an “image plane” and a movement velocity of the “object under estimation” in the real space, based on the “plurality of images” and the information related to the “capture period length” or the “capture interval length” acquired. The “image plane” is an image plane of each acquired image. The estimation unit 12 includes, for example, a neural network.

With the configuration of the estimation device 10 as described above, accuracy in estimation of a movement velocity of an object captured in images can be improved because the movement velocity of the “object under estimation” in the real space can be estimated, with the “capture period length” of or the “capture interval length” between the plurality of images used for the estimation taken into consideration. Moreover, estimation of a movement velocity of an object captured in images can be performed in a simplified manner because it is unnecessary to figure out a positional relationship between a device that captures the images and the real space captured in the images, and also because a need for preliminary processing, such as extraction of an image region of the object under estimation and tracking of the object, is eliminated. Furthermore, since camera parameters of a capturing device are not required in estimation processing, estimation of a movement velocity of an object captured in images can be performed in a simplified manner also in this respect.

### Second Example Embodiment

### <Example of Configuration of Estimation System>

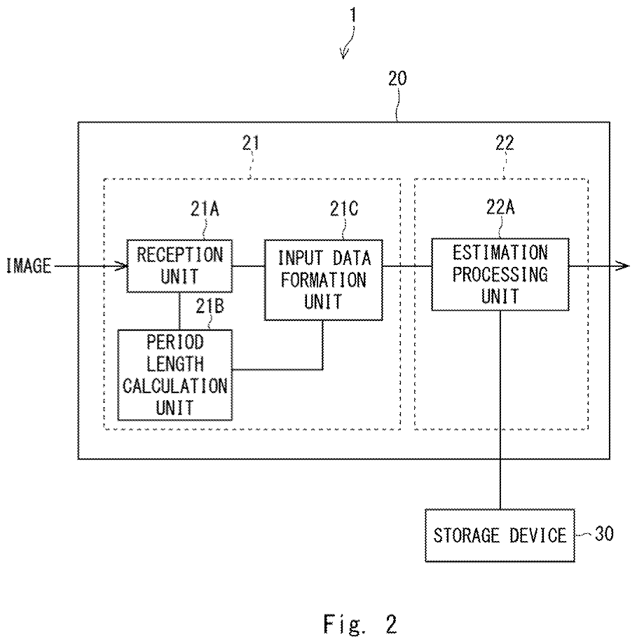

FIG. 2 is a block diagram showing an example of an estimation system including an estimation device in a second example embodiment. In FIG. 2, an estimation system 1 includes an estimation device 20 and a storage device 30.

The estimation device 20 includes an acquisition unit 21 and an estimation unit 22.

Similarly to the acquisition unit 11 in the first example embodiment, the acquisition unit 21 acquires a “plurality of images” and information related to a “capture period length” or a “capture interval length”.

For example, as shown in FIG. 2, the acquisition unit 21 includes a reception unit 21A, a period length calculation unit 21B, and an input data formation unit 21C.

The reception unit 21A receives input of the “plurality of images” captured by a camera (for example, camera 40 undermentioned).

The period length calculation unit 21B calculates the “capture period length” or the “capture interval length”, based on the “plurality of images” received by the reception unit 21A. Although a method for calculating the “capture period length” and the “capture interval length” is not particularly limited, the period length calculation unit 21B may calculate the “capture period length”, for example, by calculating a difference between an earliest time and a latest time by using time information given to each image. Alternatively, the period length calculation unit 21B may calculate the “capture period length”, for example, by measuring a time period from a timing of receiving a first one of the “plurality of images” until a timing of receiving a last one. Alternatively, the period length calculation unit 21B may calculate the “capture interval length”, for example, by calculating a difference between an earliest time and a second earliest time by using the time information given to each image. Although a description will be given below on the premise that the “capture period length” is used, the following description also applies to cases using the “capture interval length”, by replacing “capture period length” with “capture interval length”.

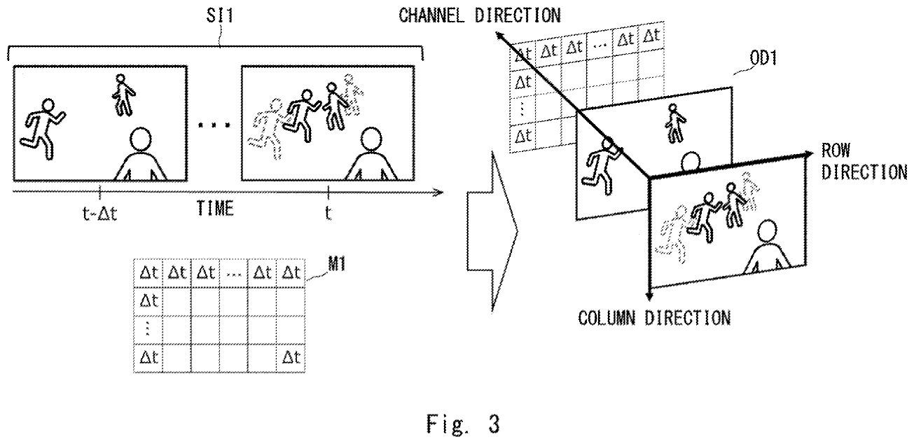

The input data formation unit 21C forms input data for the estimation unit 22. For example, the input data formation unit 21C forms a “matrix (period length matrix)”. For example, as shown in FIG. 3, the “period length matrix” is a matrix M1 in which a plurality of matrix elements correspond to a plurality of “partial regions” on the image plane, respectively, and in which a value of each matrix element is a capture period length Δt calculated by the period length calculation unit 21B. Here, each “partial region” on the image plane corresponds to, for example, one pixel. The input data formation unit 21C then outputs the input data (input data OD1 in FIG. 3) for the estimation unit 22 including the plurality of images (images SI1 in FIG. 3) received by the reception unit 21A and the period length matrix (matrix M1 in FIG. 3) formed. In other words, in the example shown in FIG. 3, what is formed by superimposing the images SI1 and the period length matrix M1 in a channel direction is the input data OD1 for the estimation unit 22. For example, when the images SI1 include three images and each image has three channels of RGB, the input data OD1 is input data with a total of 10 channels (=3 channels (RGB)×3 (the number of images)+1 channel (period length matrix M1)). In other words, by using the input data as described above, the estimation unit 22 can detect changes in appearance of an object under estimation, and thus can estimate a position of the object under estimation on the image plane and a movement velocity of the object under estimation in the real space. FIG. 3 shows an example of the input data for the estimation unit.

As shown in FIG. 2, the estimation unit 22 includes an estimation processing unit 22A.

The estimation processing unit 22A estimates a position of an object under estimation on the image plane and a movement velocity of the object under estimation in the real space by using the input data outputted from the input data formation unit 21C. The estimation processing unit 22A is, for example, a neural network.

The estimation processing unit 22A then outputs, for example, a “likelihood map” and a “velocity map” to a functional unit at an output stage (not shown). The “likelihood map” is a map in which the plurality of “partial regions” on the image plane are associated respectively with likelihoods corresponding to the individual partial regions, and each likelihood indicates a probability that the object under estimation exists in the corresponding partial region. The “velocity map” is a map in which the plurality of “partial regions” on the image plane are associated respectively with movement velocities corresponding to the individual partial regions, and each movement velocity indicates a real-space movement velocity of the object in the corresponding partial region. Note that a structure of the neural network used in the estimation processing unit 22A is not particularly limited as long as the structure is configured to output the “likelihood map” and the “velocity map”. For example, the neural network used in the estimation processing unit 22A may include, for example, a network extracting a feature map through a plurality of convolutional layers, and a plurality of deconvolutional layers, or may include a plurality of fully connected layers.

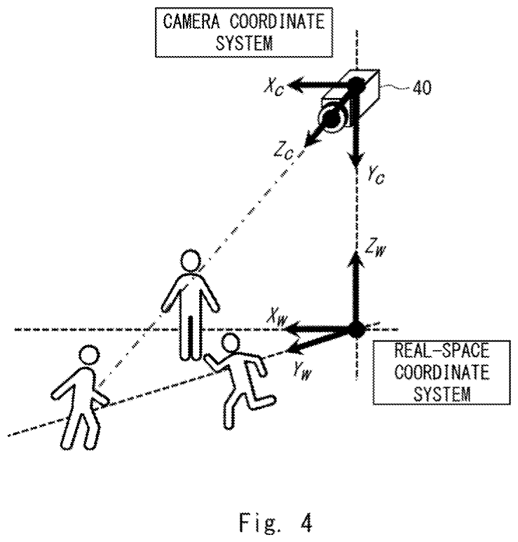

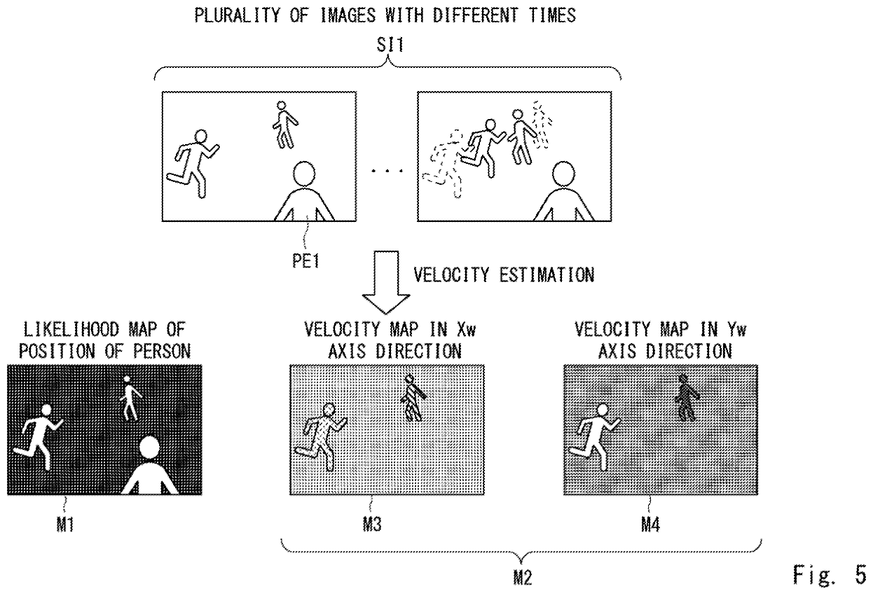

Here, an example of a relation between a camera coordinate system and a real-space coordinate system, and an example of the likelihood map and the velocity map will be described. FIG. 4 shows an example of the relation between the camera coordinate system and the real-space coordinate system. FIG. 5 shows an example of the likelihood map and the velocity map.

In FIG. 4, an origin of the camera coordinate system is set at a camera viewpoint of the camera 40. The origin of the camera coordinate system is located on a Z_{W} axis of the real-space coordinate system. A Z_{C} axis of the camera coordinate system corresponds to an optical axis of the camera 40. In other words, the Z_{C} axis of the camera coordinate system corresponds to a depth direction viewed from the camera 40. A projection along the Z_{C} axis onto an X_{W}Y_{W} plane of the real-space coordinate system overlaps a Y_{W} axis. In other words, the Z_{C} axis of the camera coordinate system and the Y_{W} axis of the real-space coordinate system overlap when viewed from a +Z_{W} direction of the real-space coordinate system. In other words, yawing (that is, rotation about a Y_{C} axis) of the camera 40 is restricted. Here, it is assumed that a plane on which “objects under estimation (here, persons)” move is the X_{W}Y_{W} plane of the real-space coordinate system.

In FIG. 5, a coordinate system serving as a basis for velocities in a velocity map M2 is the above-described real-space coordinate system. The velocity map M2 includes a velocity map M3 in an X_{W} axis direction and a velocity map M4 in a Y_{W} axis direction because the movement velocity of a person on the X_{W}Y_{W} plane of the real-space coordinate system can be decomposed into components in the X_{W} axis direction and components in the Y_{W} axis direction. Note that in the velocity maps M3 and M4, a whiter color of a region may indicate greater velocity in a positive direction of the respective axes, while a blacker color may indicate greater velocity in a negative direction of the respective axes.

Moreover, in a likelihood map M1, a whiter color of a region may indicate greater likelihood, while a blacker color may indicate less likelihood.

Here, likelihood in a region corresponding to a person PE1 in the likelihood map M1 is great, while estimated values of velocity in the region corresponding to the person PE1 in the velocity maps M3 and M4 are close to zero. This indicates that it is highly probable that the person PE1 is at a stop. In other words, the estimation unit 22 may determine that a region in which an estimated value in the velocity map M2 is less than a predefined threshold value TH_{V} and an estimated value in the likelihood map M1 is equal to or more than a predefined threshold value TH_{L}, corresponds to a person (object under estimation) who is at a stop.

Note that the relation between the camera coordinate system and the real-space coordinate system shown in FIG. 4 is an example, and can be arbitrarily set. The likelihood map and the velocity map shown in FIG. 5 are examples, and, for example, the velocity map may include a velocity map in a Z_{W} axis direction, in addition to the velocity map in the X_{W} axis direction and the velocity map in the Y_{W} axis direction.

Referring back to FIG. 2, the storage device 30 stores information related to a structure and weights of the trained neural network used in the estimation unit 22, for example, as an estimation parameter dictionary (not shown). The estimation unit 22 reads the information stored in the storage device 30, and constructs the neural network. Note that although the storage device 30 is depicted as a separate device from the estimation device 20 in FIG. 2, but is not limited to such a configuration. For example, the estimation device 20 may include the storage device 30.

A method for training the neural network is not particularly limited. For example, initial values of the individual weights of the neural network may be set at random values, and thereafter, a result of estimation may be compared with a correct answer, correctness of the result of estimation may be calculated, and the weights may be determined based on the correctness of the result of estimation.

Specifically, the weights of the neural network may be determined as follows. First, it is assumed that the neural network in the estimation unit 22 is to output a likelihood map X_{M} with a height of H and a width of W, and a velocity map X_{V} with a height of H, a width of W, and S velocity components. Moreover, it is assumed that a likelihood map Y_{M} with a height of H and a width of W and a velocity map Y_{V} with a height of H, a width of W, and S velocity components are given as “correct answer data”. Here, it is assumed that elements of the likelihood maps and the velocity maps are denoted by X_{M}(h, w), Y_{M}(h, w), X_{V}(h, w, s), and Y_{V}(h, w, s), respectively (h is an integer satisfying 1≤h≤H, w is an integer satisfying 1≤w≤W, and s is an integer satisfying 1≤s≤S). For example, when elements (h, w) of the likelihood map Y_{M} and the velocity map Y_{V} correspond to a background region, Y_{M}(h, w)=0, and Y_{V}(h, w, s)=0. In contrast, when elements (h, w) of the likelihood map Y_{M} and the velocity map Y_{V} correspond to an object region, Y_{M}(h, w)=1, and Y_{V}(h, w, s) is given a velocity of a relevant component s in the movement velocity of an object of interest.

At the time, an evaluation value L_{M} of correctness obtained when the estimated likelihood map X_{M} is compared with the correct likelihood map Y_{M} (expression (1) below), an evaluation value L_{V} of correctness obtained when the estimated velocity map X_{V} is compared with the correct velocity map Y_{V} (expression (2) below), and a total L of the evaluation values (expression (3) below) are considered.

$$\begin{matrix}[ Expression 1 ] & \\ {L}_{M} = {\sum }_{h , w} {\{ {Y}_{M} ( h , w ) - {X}_{M} ( h , w ) \}}^{2} & ( 1 ) \\ [ Expression 2 ] & \\ {L}_{V} = {\sum }_{h , w , s} {\{ {Y}_{V} ( h , w , s ) - {X}_{V} ( h , w , s ) \}}^{2} & ( 2 ) \\ [ Expression 3 ] & \\ L = {L}_{M} + {L}_{V} & ( 3 )\end{matrix}$$

The closer to the correct data a result of estimation by the neural network is, the smaller the evaluation values L_{M} and L_{V} become. Accordingly, the evaluation value L becomes smaller similarly. Values of the weights of the neural network may be obtained, therefore, such that L becomes as small as possible, for example, by using a gradient method such as stochastic gradient descent.

The evaluation values L_{M} and L_{V} may also be calculated by using following expressions (4) and (5), respectively.

$$\begin{matrix}[ Expression 4 ] & \\ {L}_{M} = {\sum }_{h , w} \{ {Y}_{M} ( h , w ) {log}_{e} {X}_{M} ( h , w ) + ( 1 - {Y}_{M} ( h , w ) ) {log}_{e} ( 1 - {X}_{M} ( h , w ) ) \} & ( 4 ) \\ [ Expression 5 ] & \\ {L}_{V} = {\sum }_{h , w , s} \vert {Y}_{V} ( h , w , s ) - {X}_{V} ( h , w , s ) \vert & ( 5 )\end{matrix}$$

The evaluation value L may also be calculated by using a following expression (6) or (7). In other words, the expression (6) represents a calculation method in which the evaluation value L_{M} is weighted by a weighting factor α, and the expression (7) represents a calculation method in which the evaluation value L_{V} is weighted by the weighting factor α.

$$\begin{matrix}[ Expression 6 ] & \\ L = α {L}_{M} + {L}_{V} & ( 6 ) \\ [ Expression 7 ] & \\ L = {L}_{M} + α {L}_{V} & ( 7 )\end{matrix}$$

In addition, a method for creating the correct data used when the weights of the neural network are obtained is not limited either. For example, the correct data may be created by manually labeling positions of an object in a plurality of videos with different angles of camera view and frame rates, and measuring the movement velocity of the object by using another measurement instrument, or may be created by a method of simulating a plurality of videos with different angles of camera views and frame rates by using computer graphics.

A range of a region of a person (object under estimation) to be set in the likelihood map and the velocity map that are the correct answer data, is not limited either. For example, in the likelihood map and the velocity map that are the correct answer data, a whole body of a person may be set for the range of the region of a person, or only a range of a region that favorably indicates movement velocity may be set as the range of the region of a person. Thus, the estimation unit 22 can output the likelihood map and the velocity map with respect to part of an object under estimation that favorably indicates the movement velocity of the object under estimation.

### <Example of Operation of Estimation Device>

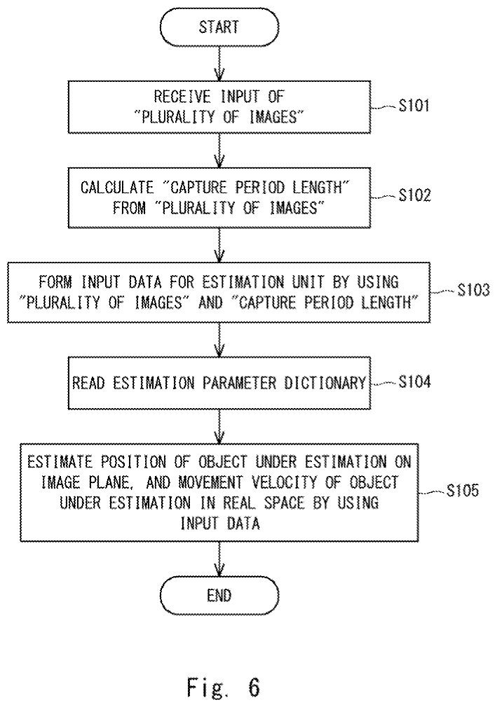

An example of processing operation of the above-described estimation device 20 will be described. FIG. 6 is a flowchart showing an example of the processing operation of the estimation device in the second example embodiment.

The reception unit 21A receives input of a “plurality of images” captured by a camera (step S101).

The period length calculation unit 21B calculates a “capture period length” from the “plurality of images” received by the reception unit 21A (step S102).

The input data formation unit 21C forms input data for the estimation unit 22 by using the “plurality of images” received by the reception unit 21A and the “capture period length” calculated by the period length calculation unit 21B (step S103).

The estimation processing unit 22A reads the estimation parameter dictionary stored in the storage device 30 (step S104). Thus, the neural network is constructed.

The estimation processing unit 22A estimates a position of an object under estimation on the image plane, and a movement velocity of the object under estimation in the real space by using the input data outputted from the input data formation unit 21C (step S105). The position of the object under estimation on the image plane and the movement velocity of the object under estimation in the real space estimated are outputted, for example, as a “likelihood map” and a “velocity map”, to an undepicted output device (for example, display device).

As described above, according to the second example embodiment, in the estimation device 20, the estimation processing unit 22A estimates a position of an “object under estimation” on the “image plane” and a movement velocity of the “object under estimation” in the real space, based on input data including a “plurality of images” received by the reception unit 21A, and a “period length matrix” based on a “capture period length” or a “capture interval length” calculated by the period length calculation unit 21B.

With such a configuration of the estimation device 20, accuracy in estimation of a movement velocity of an object captured in images can be improved because the movement velocity of the “object under estimation” in the real space can be estimated, with a “capture period length” of or a “capture interval length” between the plurality of images used for the estimation taken into consideration. Moreover, estimation of a movement velocity of an object captured in images can be performed in a simplified manner because it is unnecessary to figure out a positional relationship between a device that captures the images (for example, the camera 40) and a space captured in the images, and also because a need for preliminary processing, such as extraction of an image region of the object under estimation and tracking of the object, is eliminated. Furthermore, since camera parameters of the camera 40 are not required in estimation processing, estimation of a movement velocity of an object captured in images can be performed in a simplified manner also in this respect.

### Third Example Embodiment

### <Example of Configuration of Estimation System>

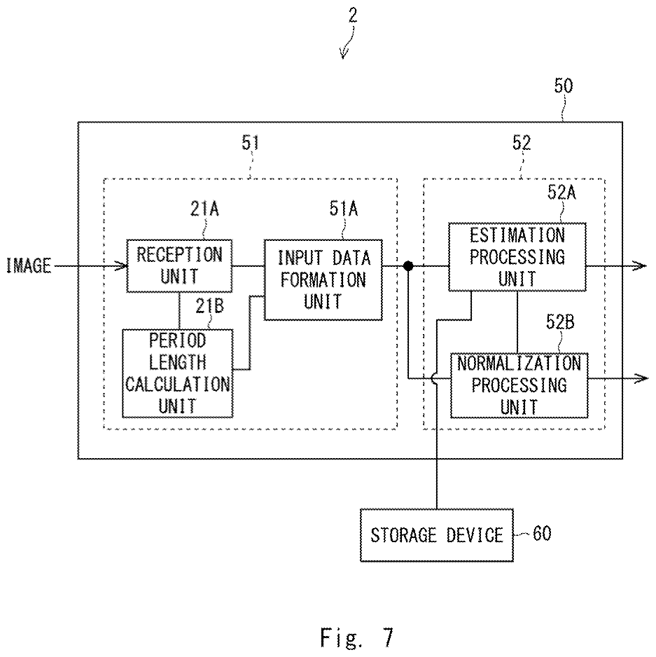

FIG. 7 is a block diagram showing an example of an estimation system including an estimation device in a third example embodiment. In FIG. 7, an estimation system 2 includes an estimation device 50 and a storage device 60.

The estimation device 50 includes an acquisition unit 51 and an estimation unit 52.

Similarly to the acquisition unit 21 in the second example embodiment, the acquisition unit 51 acquires a “plurality of images” and information related to a “capture period length”.

For example, as shown in FIG. 7, the acquisition unit 51 includes the reception unit 21A, the period length calculation unit 21B, and an input data formation unit 51A. In other words, in comparison with the acquisition unit 21 in the second example embodiment, the acquisition unit 51 includes the input data formation unit 51A instead of the input data formation unit 21C.

The input data formation unit 51A outputs input data for the estimation unit 52, including the plurality of images received by the reception unit 21A and the capture period length, or a capture interval length, calculated by the period length calculation unit 21B. In other words, unlike the input data formation unit 21C in the second example embodiment, the input data formation unit 51A directly outputs the capture period length or the capture interval length to the estimation unit 52, without forming a “period length matrix”. The plurality of images included in the input data for the estimation unit 52 are inputted into an estimation processing unit 52A, which will be described later, and the capture period length or the capture interval length included in the input data for the estimation unit 52 is inputted into a normalization processing unit 52B, which will be described later.

As shown in FIG. 7, the estimation unit 52 includes the estimation processing unit 52A and the normalization processing unit 52B.

The estimation processing unit 52A reads information stored in the storage device 60 and constructs a neural network. The estimation processing unit 52A then estimates a position of an object under estimation on the image plane and a movement velocity of the object under estimation in the real space by using the plurality of images received from the input data formation unit 51A. In other words, unlike the estimation processing unit 22A in the second example embodiment, the estimation processing unit 52A does not use the capture period length or the capture interval length in estimation processing. Here, similarly to the storage device 30 in the second example embodiment, the storage device 60 stores information related to a structure and weights of the trained neural network used in the estimation processing unit 52A, for example, as an estimation parameter dictionary (not shown). However, a capture period length of or a capture interval length between images in correct answer data used when the weights of the neural network are obtained, is fixed at a predetermined value (fixed value).

The estimation processing unit 52A then outputs a “likelihood map” to a functional unit at an output stage (not shown), and outputs a “velocity map” to the normalization processing unit 52B.

The normalization processing unit 52B normalizes the “velocity map” outputted from the estimation processing unit 52A by using the “capture period length” or the “capture interval length” received from the input data formation unit 51A, and outputs the normalized velocity map to the functional unit at the output stage (not shown). Here, as described above, the weights of the neural network used in the estimation processing unit 52A are obtained based on a plurality of images with the certain capture period length (fixed length) or the certain capture interval length (fixed length). Accordingly, the normalization processing unit 52B normalizes the “velocity map” outputted from the estimation processing unit 52A by using a ratio between the “capture period length” or the “capture interval length” received from the input data formation unit 51A and the above-mentioned “fixed length”. Thus, velocity estimation is possible that takes into consideration the capture period length or the capture interval length calculated by the period length calculation unit 21B.

### <Example of Operation of Estimation Device>

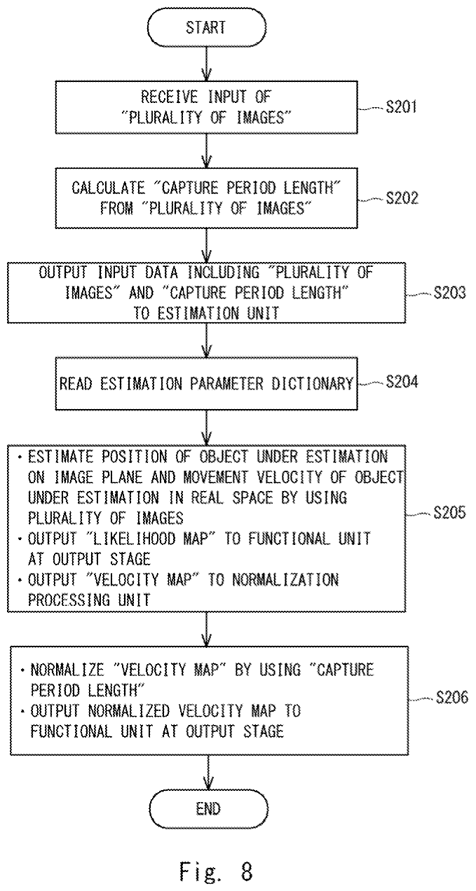

An example of processing operation of the above-described estimation device 50 will be described. FIG. 8 is a flowchart showing an example of the processing operation of the estimation device in the third example embodiment. Although a description will be given below on the premise that the “capture period length” is used, the following description also applies to cases using the “capture interval length”, by replacing “capture period length” with “capture interval length”.

The reception unit 21A receives input of a “plurality of images” captured by a camera (step S201).

The period length calculation unit 21B calculates a “capture period length” from the “plurality of images” received by the reception unit 21A (step S202).

The input data formation unit 51A outputs input data including the “plurality of images” received by the reception unit 21A and the “capture period length” calculated by the period length calculation unit 21B, to the estimation unit 52 (step S203). Specifically, the plurality of images are inputted into the estimation processing unit 52A, and the capture period length is inputted into the normalization processing unit 52B.

The estimation processing unit 52A reads the estimation parameter dictionary stored in the storage device 60 (step S204). Thus, the neural network is constructed.

The estimation processing unit 52A estimates a position of an object under estimation on the image plane and a movement velocity of the object under estimation in the real space by using the plurality of images received from the input data formation unit 51A (step S205). Then, the estimation processing unit 52A outputs a “likelihood map” to the functional unit at the output stage (not shown), and outputs a “velocity map” to the normalization processing unit 52B (step S205).

The normalization processing unit 52B normalizes the “velocity map” outputted from the estimation processing unit 52A by using the “capture period length” received from the input data formation unit 51A, and outputs the normalized velocity map to the functional unit at the output stage (not shown) (step S206).

With the configuration of the estimation device 50 as described above, effects similar to those of the second example embodiment can also be obtained.

### Other Example Embodiments

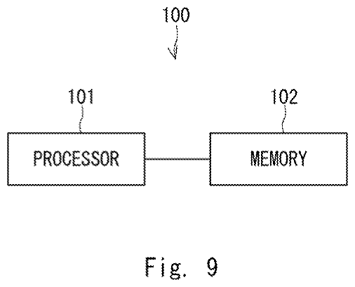

FIG. 9 shows an example of a hardware configuration of an estimation device. In FIG. 9, an estimation device 100 includes a processor 101 and a memory 102. The processor 101 may be, for example, a microprocessor, an MPU (Micro Processing Unit), or a CPU (Central Processing Unit). The processor 101 may include a plurality of processors. The memory 102 is configured with a combination of a volatile memory and a non-volatile memory. The memory 102 may include a storage placed away from the processor 101. In such a case, the processor 101 may access the memory 102 via an undepicted I/O interface.

Each of the estimation devices 10, 20, 50 in the first to third example embodiments can have the hardware configuration shown in FIG. 9. The acquisition units 11, 21, 51 and the estimation units 12, 22, 52 of the estimation devices 10, 20, 50 in the first to third example embodiments may be implemented by the processor 101 reading and executing a program stored in the memory 102. Note that when the storage devices 30, 60 are included in the estimation devices 20, 50, the storage devices 30, 60 may be implemented by the memory 102. The program can be stored by using any of various types of non-transitory computer-readable media, and can be provided to the estimation devices 10, 20, 50. Examples of the non-transitory computer-readable media include magnetic recording media (for example, flexible disk, magnetic tape, hard disk drive) and magneto-optical recording media (for example, magneto-optical disk). Moreover, examples of the non-transitory computer-readable media include CD-ROM (Read Only Memory), CD-R, and CD-R/W. Further, examples of the non-transitory computer-readable media include semiconductor memory. Semiconductor memories include, for example, mask ROM, PROM (Programmable ROM), EPROM (Erasable PROM), flash ROM, and RAM (Random Access Memory). The program may also be provided to the estimation devices 10, 20, 50 by using any of various types of transitory computer-readable media. Examples of the transitory computer-readable media include electric signal, optical signal, and electromagnetic waves. The transitory computer-readable media can provide the program to the estimation devices 10, 20, 50 through a wired communication channel such as an electric wire or a fiber-optic line, or a wireless communication channel.

The invention of the present application has been described hereinabove by referring to some embodiments. However, the invention of the present application is not limited to the matters described above. Various changes that are comprehensible to persons ordinarily skilled in the art may be made to the configurations and details of the invention of the present application, within the scope of the invention.

Part or all of the above-described example embodiments can also be described as in, but are not limited to, following supplementary notes.

### (Supplementary Note 1)

An estimation device comprising:

an acquisition unit configured to acquire a plurality of images and information related to a capture period length or a capture interval length, the plurality of images being images in each of which a real space is captured and having mutually different capture times, the capture period length corresponding to a difference between an earliest time and a latest time of the plurality of times that correspond to the plurality of images, respectively, the capture interval length corresponding to a difference between the times of two images that are next to each other when the plurality of images are arranged in chronological order of the capture times; and

an estimation unit configured to estimate a position of an object under estimation on an image plane and a movement velocity of the object under estimation in the real space, based on the plurality of images and the information related to the capture period length or the capture interval length acquired.

### (Supplementary Note 2)

The estimation device according to Supplementary Note 1, wherein the estimation unit is configured to output a likelihood map and a velocity map, the likelihood map being a map in which a plurality of partial regions on the image plane are associated respectively with likelihoods corresponding to the individual partial regions, the likelihood map indicating a probability that the object under estimation exists in a partial region to which each likelihood corresponds, the velocity map being a map in which the plurality of partial regions are associated respectively with movement velocities corresponding to the individual partial regions, the velocity map indicating a real-space movement velocity of the object in a partial region to which each movement velocity corresponds.

### (Supplementary Note 3)

The estimation device according to Supplementary Note 1 or 2, wherein the acquisition unit includes

a reception unit configured to receive input of the plurality of images,

a period length calculation unit configured to calculate the capture period length or the capture interval length from the plurality of images received, and

an input data formation unit configured to form a matrix, and output input data for the estimation unit including the plurality of images received and the matrix formed, the matrix including a plurality of matrix elements that correspond to a plurality of partial regions on the image plane, respectively, a value of each matrix element being the capture period length or the capture interval length.

### (Supplementary Note 4)

The estimation device according to Supplementary Note 3, wherein the estimation unit includes an estimation processing unit configured to estimate the position of the object under estimation on the image plane and the movement velocity of the object under estimation in the real space, by using the input data outputted.

### (Supplementary Note 5)

The estimation device according to Supplementary Note 1 or 2, wherein the acquisition unit includes

a reception unit configured to receive input of the plurality of images,

a period length calculation unit configured to calculate the capture period length or the capture interval length from the plurality of images received, and

an input data formation unit configured to output input data for the estimation unit including the plurality of images received and the capture period length or the capture interval length calculated.

### (Supplementary Note 6)

The estimation device according to Supplementary Note 5, wherein the estimation unit includes

an estimation processing unit configured to estimate the movement velocity of the object under estimation in the real space, based on the plurality of images in the input data outputted, and

a normalization processing unit configured to normalize the movement velocity estimated by the estimation processing unit, by using the capture period length or the capture interval length in the input data outputted.

### (Supplementary Note 7)

The estimation device according to Supplementary Note 2, wherein the estimation unit is configured to output the likelihood map and the velocity map with respect to part of the object under estimation that favorably indicates the movement velocity of the object under estimation.

### (Supplementary Note 8)

The estimation device according to Supplementary Note 4 or 6, wherein the estimation processing unit includes a neural network.

### (Supplementary Note 9)

An estimation system comprising:

the estimation device according to Supplementary Note 8; and

a storage device storing information related to a configuration and weights of the neural network.

### (Supplementary Note 10)

An estimation method comprising:

acquiring a plurality of images and information related to a capture period length or a capture interval length, the plurality of images being images in each of which a real space is captured and having mutually different capture times, the capture period length corresponding to a difference between an earliest time and a latest time of the plurality of times that correspond to the plurality of images, respectively, the capture interval length corresponding to a difference between the times of two images that are next to each other when the plurality of images are arranged in chronological order of the capture times; and

estimating a position of an object under estimation on an image plane and a movement velocity of the object under estimation in the real space, based on the plurality of images and the information related to the capture period length or the capture interval length acquired.

### (Supplementary Note 11)

A non-transitory computer-readable medium storing a program, the program causing an estimation device to execute processing including:

acquiring a plurality of images and information related to a capture period length or a capture interval length, the plurality of images being images in each of which a real space is captured and having mutually different capture times, the capture period length corresponding to a difference between an earliest time and a latest time of the plurality of times that correspond to the plurality of images, respectively, the capture interval length corresponding to a difference between the times of two images that are next to each other when the plurality of images are arranged in chronological order of the capture times; and

estimating a position of an object under estimation on an image plane and a movement velocity of the object under estimation in the real space, based on the plurality of images and the information related to the capture period length or the capture interval length acquired.

### REFERENCE SIGNS LIST

1 ESTIMATION SYSTEM
2 ESTIMATION SYSTEM
10 ESTIMATION DEVICE
11 ACQUISITION UNIT
12 ESTIMATION UNIT
20 ESTIMATION DEVICE
21 ACQUISITION UNIT
21A RECEPTION UNIT
21B PERIOD LENGTH CALCULATION UNIT
21C INPUT DATA FORMATION UNIT
22 ESTIMATION UNIT
22A ESTIMATION PROCESSING UNIT
30 STORAGE DEVICE
40 CAMERA
50 ESTIMATION DEVICE
51 ACQUISITION UNIT
51A INPUT DATA FORMATION UNIT
52 ESTIMATION UNIT
52A ESTIMATION PROCESSING UNIT
52B NORMALIZATION PROCESSING UNIT
60 STORAGE DEVICE

What is claimed is:

1. An estimation device comprising:
at least one memory storing instructions, and
at least one processor configured to execute a process including:
acquiring a plurality of images and information related to a capture period length or a capture interval length, the plurality of images being images in each of which a real space is captured and having mutually different capture times, the capture period length corresponding to a difference between an earliest time and a latest time of the plurality of times that correspond to the plurality of images, respectively, the capture interval length corresponding to a difference between the times of two images that are next to each other when the plurality of images are arranged in chronological order of the capture times; and
estimating a position of an object under estimation on an image plane and a movement velocity of the object under estimation in the real space, based on the plurality of images and the information related to the capture period length or the capture interval length acquired.

2. The estimation device according to claim 1, wherein the process includes outputting a likelihood map and a velocity map, the likelihood map being a map in which a plurality of partial regions on the image plane are associated respectively with likelihoods corresponding to the individual partial regions, the likelihood map indicating a probability that the object under estimation exists in a partial region to which each likelihood corresponds, the velocity map being a map in which the plurality of partial regions are associated respectively with movement velocities corresponding to the individual partial regions, the velocity map indicating a real-space movement velocity of the object in a partial region to which each movement velocity corresponds.

3. The estimation device according to claim 1, wherein the acquiring includes
receiving input of the plurality of images,
calculating the capture period length or the capture interval length from the plurality of images received, and
forming a matrix, and outputting input data for the estimating including the plurality of images received and the matrix formed, the matrix including a plurality of matrix elements that correspond to a plurality of partial regions on the image plane, respectively, a value of each matrix element being the capture period length or the capture interval length.

4. The estimation device according to claim 3, wherein the estimating includes estimating the position of the object under estimation on the image plane and the movement velocity of the object under estimation in the real space, by using the input data outputted.

5. The estimation device according to claim 1, wherein the acquiring includes
receiving input of the plurality of images,
calculating the capture period length or the capture interval length from the plurality of images received, and
outputting input data for the estimating including the plurality of images received and the capture period length or the capture interval length calculated.

6. The estimation device according to claim 5, wherein the estimating includes
estimating the movement velocity of the object under estimation in the real space, based on the plurality of images in the input data outputted, and
normalizing the movement velocity estimated by the estimating, by using the capture period length or the capture interval length in the input data outputted.

7. The estimation device according to claim 2, wherein the outputting includes outputting the likelihood map and the velocity map with respect to part of the object under estimation that favorably indicates the movement velocity of the object under estimation.

8. The estimation device according to claim 4, wherein the at least one processor includes a neural network.

9. An estimation system comprising:
the estimation device according to claim 8; and
a storage device storing information related to a configuration and weights of the neural network.

10. An estimation method comprising:
acquiring a plurality of images and information related to a capture period length or a capture interval length, the plurality of images being images in each of which a real space is captured and having mutually different capture times, the capture period length corresponding to a difference between an earliest time and a latest time of the plurality of times that correspond to the plurality of images, respectively, the capture interval length corresponding to a difference between the times of two images that are next to each other when the plurality of images are arranged in chronological order of the capture times; and
estimating a position of an object under estimation on an image plane and a movement velocity of the object under estimation in the real space, based on the plurality of images and the information related to the capture period length or the capture interval length acquired.

11. A non-transitory computer-readable medium storing a program, the program causing an estimation device to execute processing including:
acquiring a plurality of images and information related to a capture period length or a capture interval length, the plurality of images being images in each of which a real space is captured and having mutually different capture times, the capture period length corresponding to a difference between an earliest time and a latest time of the plurality of times that correspond to the plurality of images, respectively, the capture interval length corresponding to a difference between the times of two images that are next to each other when the plurality of images are arranged in chronological order of the capture times; and
estimating a position of an object under estimation on an image plane and a movement velocity of the object under estimation in the real space, based on the plurality of images and the information related to the capture period length or the capture interval length acquired.
